(19) United States
(12) Patent Application Publication
(10) Pub. No.: US 2006/0290311 A1
(43) Pub. Date: Dec. 28, 2006

(54) Method and System for Synchronizing Networked Passive Systems

(76) Inventors: Nikhil Chopra, Champaign, IL (US); Mark W. Spong, Champaign, IL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/427,227

(22) Filed: Jun. 28, 2006

Related U.S. Application Data
(60) Provisional application No. 60/694,905, filed on Jun. 28, 2005.

(51) Int. Cl. G05B 19/19

(52) U.S. Cl. 318/568.11

(57) ABSTRACT

A control system for output synchronization of a networked communication system comprises a plurality of agents governed by control affine passive dynamics, each of the plurality of agents being coupled to the networked communication system which facilitates data exchange between the plurality of agents with induced delays, and a plurality of controller blocks, each one associated with one of the plurality of agents. Each of the plurality of the controller blocks uses output signals received from the associated agent and from a subset of the plurality of agents to derive a synchronizing control for the associated agent, so that the output signals of the plurality of agents converge asymptotically with time and so that the plurality of agents are synchronized to each other.

### RELATED APPLICATIONS

This application claims priority to Provisional Application No. 60/694,905, filed on Jun. 28, 2005, which is hereby incorporated by reference.

This invention was made with government support under Office of Naval Research grant No.: N000140510186. The government has certain rights to this invention.

### FIELD OF INVENTION

The present invention relates, in general, to networked passive systems and, more particularly, to a method and a system for synchronizing networked passive systems.

### BACKGROUND

Network passive systems are encountered in a variety of technical applications. One such technical application is an area of bilateral teleoperations. In a bilateral teleoperation, a human operator conducts a task in a remote environment via master and slave manipulators or robots. Potential tasks of bilateral teleoperations include works in hazardous and remote environments, security surveillance, search and rescue robots, autonomous vehicles, autonomous locomotion systems and remote surgery.

Typically, a teleoperation requires synchronization between master and slave robots. To improve a performance of these tasks, a feel of the remote environment is needed. This feel of the remote environment can be accomplished by providing contact force information to the human operator. The contact force information is generally achieved via visual feedback or reflection of the measured force back to the human operator. The latter has proven to be more useful. Generally, teleoperations are conducted via control signals over communication networks between master and slave robots. Typically, these control signals suffer a time delay in reaching from the human operator (master robot side) to the remote (slave robot) site and then back to the master robot side. This time delay may cause instability in teleoperation systems.

This teleoperation problem has been known for about 35 years. Interest in this teleoperation problem is easily seen by the amount of related technical work found the literature. Around 900 papers have been published in various IEEE Journals and conferences in the last 13 years, as well as about 186 patents have been issued by the United States Patent and Trademark Office (USPTO) in the last five years alone, which address various issues in teleoperation. However, most of these patents address hardware issues in teleoperation. There are two patents which address the issue of time-delay in the teleoperation systems, namely U.S. Pat. No. 5,266,875 ('875) and U.S. Pat. No. 6,144,884 ('884). Both of these patents are incorporated herein in their entirety by reference.

In regard to the '875 patent, issued on Nov. 30, 1993 to Slotine et al., an algorithm is disclosed for conducting teleoperations over constant delay networks. This '875 patent outlined a use of the wave variable transformation for stabilizing bilateral teleoperations.

In regard to the '884 patent, issued in 2000 to Niemeyer et al., a method is provided to address a problem of time-varying delays in teleoperations, while building upon the aforementioned '875 patent. However, the proposed method to handle the time-varying delays ensured a stability of teleoperations in a substantially restrictive way. The achieved performance failed to compare to the performance achieved in a case of constant delay teleoperations.

Thus, the wave variables methodology can lead to conservative performances in bilateral teleoperation systems due to poor tracking performance and wave reflection phenomenon.

In view of the above discussion, it would be desirable to provide a method and system that achieves excellent tracking performance while overcoming the destabilizing effects of the time delays, and therefore performs bilateral teleoperations in a stable and efficient manner.

### BRIEF SUMMARY

The present invention is defined by the appended claims. This description summarizes some aspects of the present embodiments and should not be used to limit the claims.

One object is to provide a control system for output synchronization of a networked passive system. The control system comprises a plurality of agents governed by control affine passive dynamics, each of the plurality of agents being coupled to the networked communication system which facilitates data exchange between the plurality of agents, and a plurality of controller blocks, each one associated with one of the plurality of agents. Each of the plurality of the controller blocks uses output signals received from the associated agent and from a subset of the plurality of agents to derive a synchronizing control for the associated agent, so that the output signals of the plurality of agents mutually converge asymptotically with time and so that the plurality of agents are synchronized to each other.

Another object is to provide a control system for a bilateral teleoperation. The control system comprises a master system, which includes a master controller configured to produce output signal rₘ representing an action of the master system, and configured for coupling to a communication system. A slave system is provided which includes a slave controller coupled to the master controller through the communication system via a bidirectional communication path which may induce time delay on the output signal. The slave controller is configured to produce an output signal vector rₛ, representing a reaction to the output signal rₘ. Coupling torque signals Fₘ and Fₛ, which are functions of the output signals rₘ and rₛ, and are provided to the master and the slave controllers respectively, are minimized during the bilateral teleoperation to synchronize the master and slave systems.

A further object is to provide a method for bilateral teleoperation. The method comprises producing an output signal rₘ representing an action of a master system, which includes a master controller configured for coupling to a communication system, producing an output signal vector rₛ, representing a reaction by a slave system to the output signal rₘ. The slave system includes a slave controller coupled to the master controller through the communication system via a bidirectional communication path which may induce time delay on the output signal. The method further comprises minimizing coupling torque signals Fₘ and Fₛ, which are functions of the output signals rₘ and rₛ, and are provided to the master and the slave controllers respectively, during the bilateral teleoperation to synchronize the master and slave systems.

Exemplary embodiments of the invention are described in further detail below in conjunction with the drawings.

### BRIEF DESCRIPTION OF THE DRAWINGS

FIG. 1 illustrates a schematic diagram of a ring topology of a system of four agents;

FIG. 2 illustrates a schematic block diagram of a bilateral teleoperation;

FIG. 3 illustrates a schematic block diagram of a coordinated bilateral teleoperation;

FIG. 4 is a flow diagram of a method for conducting the coordinated bilateral teleoperation; and

FIG. 5 is a graph illustrating output signals of four agents converging after a period of time.

### DETAILED DESCRIPTION OF THE DRAWINGS

The present invention is defined by the appended claims. This description summarizes some aspects of the present embodiments and should not be used to limit the claims

Passivity is an appealing concept of system theory and has been widely used as a tool in the development of linear and nonlinear feedback designs. Moreover, an understanding of the interaction between a plurality of networked dynamic passive systems, namely their output synchronization, is desired. As such, a method for an output synchronization of N dynamic passive agents is provided. An application of this method for an output synchronization of passive systems to a bilateral teleoperation is also provided.

The dynamic systems described herein are control affine systems and their dynamic evolution in time can be described by the following equation:
xᵢ=fᵢ(xᵢ)+gᵢ(xᵢ)uᵢ
yᵢ=hᵢ(xᵢ)i=1, . . . , N Equation 1
where xᵢεRⁿ, fᵢ(.)εRⁿ, gᵢ(.)εR^{nxm}, uᵢεR^{m}, hᵢ(.)εR^{m}, and with fᵢ(0)=0, hᵢ(0)=0, hᵢ(0)=0.

Admissible controls are taken to locally square integrable. The vector fields, appearing in Equation 1, have sufficient smoothness so that a unique solution exists for all times. The agents are said to output synchronize if:
yi−yj →0 as t→∞∀ᵢ, j=1, . . . N Equation 2

The system described by Equation 1 is said to be passive with (uᵢ, yᵢ) as an input-output pair if there exists a C¹ storage function Vi (xi)>0, Vi(0)=0 such that for all t>=0

$${V}_{i} ( {x}_{i} ) - {V}_{i} ( {x}_{i} ( 0 ) ) \leq {\int }_{0}^{t} {u}_{i}^{T} ( s ) {y}_{i} ( s ) ⅆ s \qquad Equation 3$$

Now, a theorem originally proposed in Moylan is recited herein as a relaxed version proposed by Lozano et al., as follows:

Considering the nonlinear system described by Equation 1, the following two statements are equivalent:
1. There exists a C¹ storage function Vᵢ(xᵢ)>0, Vᵢ(0)=0 and a function Sᵢ(xᵢ)>=0 such that for all t>=0

$${V}_{i} ( {x}_{i} ) - {V}_{i} ( {x}_{i} ( 0 ) ) = {\int }_{0}^{t} {u}_{i}^{T} ( s ) {y}_{i} ( s ) ⅆ s - {\int }_{0}^{t} {S}_{i} ( {x}_{i} ( s ) ) ⅆ s \qquad Equation 4$$
The system is Strictly Passive for Sᵢ(xᵢ)>0, Passive for Sᵢ(xᵢ)>=0 and Lossless for Sᵢ(xᵢ)=0.
2. There exists a C¹ scalar function Vᵢ(xᵢ)>0, Vi(0)=0, such that:

$${L}_{fi} {V}_{i} ( {x}_{i} ) = - {S}_{i} ( {x}_{i} ) \\ {L}_{gi} {V}_{i} ( {x}_{i} ) = {h}_{i}^{T} ( {x}_{i} ) \\ where \\ {L}_{f} {iV}_{i} ( {x}_{i} ) = \frac{\partial {V}_{i}^{T}}{\partial {x}_{i}} {f}_{i} ( {x}_{i} ) \\ and \\ {L}_{gi} {V}_{i} ( {x}_{i} ) = \frac{\partial {V}_{i}^{T}}{\partial x} {g}_{i} ( {x}_{i} ) \qquad Equation 5$$

The dynamic systems, discussed herein, are passive with a positive definite storage function, i.e., Vᵢ(xᵢ)>0, or if xᵢ is not equal to zero (0).

Moreover, control strategies are provided for synchronization of the passive systems that are networked using a general interconnection topology. These passive systems have radially unbounded C² positive-definite storage functions given by V₁(x₁), V₂, (x₂), . . . , V_{N}(x_{N}) respectively.

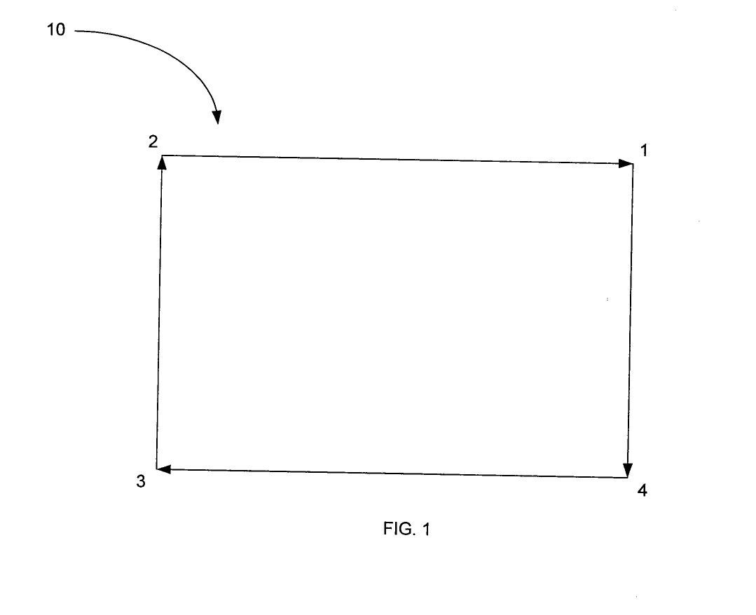

Output synchronization results are now addressed for both fixed and arbitrarily switching graphs. Hereafter, a communication graph or topology is balanced and weakly connected unless otherwise specified. The communication graph is considered to be balanced if the number of input signals received by an agent is equal to the number of output signals it transmits to the other agents. An example of such topology is a system of 4 agents 1, 2, 3, and 4 illustrated in FIG. 1. Further, the communication graph is considered to be weakly connected if there is a path from every agent to every other agent.

Now, in the case where the communication topology is fixed, i.e., the information graph does not change with time. Suppose that the agents are coupled together using the control.

$${u}_{i} = {\sum }_{j ∈ Ni} K ( {y}_{j} - {y}_{i} ) , i = 1 , … , N \qquad Equation 6$$

where K is a positive constant and Nᵢ is the set of agents transmitting their outputs to the i^{th} agent.

In this case, if the communication or interconnection graph is weakly connected and balanced, then the system is globally stable and the agents output synchronize. Moreover, a strong connectivity of the system implies output synchronization of the dynamic system described by Equation 1. Moreover, although the coupling gain K was taken to be a constant for simplicity. The result can be easily extended to the case where K is a positive definite matrix.

Now, another case is considered when the graph topology is not constant, such as in nearest neighbor scenarios. In this case of linear coupling, output synchronization is still acheived for arbitrary switching as long as the graph remains balanced and weakly connected over bounded time intervals.

Consider now the coupling control law given below:

$${u}_{i} ( t ) = {\sum }_{j ∈ {N}_{i} ( t )} K ( t ) ( {y}_{j} - {y}_{i} ) , i = 1 , … , N \qquad Equation 7$$

In this equation both the gain K(t)>0 and the set Nᵢ of neighbors of agent I are time-dependent, and the gain K(t) satisfies:
Kₗ≦K(t)≦K_{b}, Kₗ, K_{b}>0∀i,j Equation 8

As such, output synchronization is achieved provided the agents are weakly connected pointwise in time.

In another scenario, the agents are allowed to lose connectivity at every instant, but maintain connectivity in an average sense to be made precise. Let tᵢⱼ(e),tᵢⱼ(d) denote the time instances at which the information link or the edge (i,j) is established and broken respectively, i.e. a dwell time. In the subsequent analysis we require that
tᵢⱼ(d)−tᵢⱼ(e)≧δ>0∀i,j ∈ε Equation 9

The above assumption does not require the dwell time to be the same for every agent, but implies it to be uniformly bounded away from zero.

By definition, the agents are said to be jointly connected across the time interval [t, t+T], T>0 if the agents are weakly connected across the union {E(G(t)), . . . , E(G(t+T))}, where E(G(t)) denotes the time varying set of edges of the interconnection graph.

As such, the dynamical system described by Equation 1 coupled together using the control described by Equation 7 and with the assumption that the agents form a balanced information graph and are jointly connected, then the dynamic system is globally stable and the agents output synchronize.

Note that if the graph is undirected, the above results are still valid in the case that different gains (or weights) Kᵢⱼ(t) couple the agents, provided Kᵢⱼ(t)=Kᵢⱼ(t) ∀i,j.

Now, the problem of output synchronization when there are communication delays in the network is addressed. The delays are considered to be constant and bounded, and Tᵢⱼ denotes the communication delay from the i^{th} agent to the j^{th} agent. Tᵢⱼ need not be necessarily equal to Tⱼᵢ.

By definition, the agents are said to output synchronize if

$${lim}_{t -> ∞} \vert {y}_{i} ( t - {T}_{ij} ) - {y}_{j} ( t ) \vert = 0 ∀ i , j \qquad Equation 10$$

where Tᵢⱼ is the sum of the delays along the path from the i^{th} agent to the j^{th} agent.

As before, output synchronization follows if the interconnection graph is time invariant, balanced and the agents are weakly connected pointwise in time. Hereafter, results for N passive systems connected via a unidirectional ring topology are provided. This ring topology refers to the way the agents are interconnected to each other.

An example of such topology is the aforementioned system of 4 agents 1, 2, 3, and 4, illustrated in FIG. 1. That is, as time delays are induced in the network, the agents receive a delayed version of the outputs of other agents. The agents are coupled together using a control, which is given as follows:
uᵢ=K(yᵢ+1(t−T)−yᵢ)i=1, . . . , N−1
u_{N}=K(y₁(t−T)−y_{N}) Equation 11
where T is a constant time-delay in the network and K>0 is a constant.

Accordingly, a theorem encapsulating the synchronization of the nonlinear passive systems states as follows:
“Consider the dynamical system described by Equation 1 and coupled together using the control described by Equation 11, then for all arbitrary initial conditions, all signals in the system are bounded and the nonlinear systems described by Equation 1 are output synchronized.”

A proof for this theorem is as follows:

Consider a positive definite Lyapunov function for the dynamic system be given as:

$$V = 2 ( {V}_{1} + … + {V}_{N} ) + K {\int }_{t - T}^{t} ( {y}_{1}^{T} {y}_{1} + … + {y}_{N}^{T} {y}_{N} {ⅆ}_{T} \qquad Equation 12$$

A derivative of this Lyapunov function along trajectories of the system is given as:

$$\dot{V} = 2 {\sum }_{i = 1}^{N} ( {L}_{fi} {V}_{i} + {L}_{gi} {V}_{iui} ) + K {\sum }_{i = 1}^{N} ( {y}_{i}^{T} yi - {yi ( t - T )}^{T} yi ( t - T ) ) \qquad Equation 13$$

Using the previous theorem, this Lyapunov derivative reduces to:

$$\begin{matrix}\dot{V} = 2 {\sum }_{t = 1}^{N} ( {L}_{fi} {V}_{i} + {y}_{i}^{T} {u}_{i} ) + K {\sum }_{i = 1}^{N} ( {y}_{i}^{T} {y}_{i} - \\ {{y}_{i} ( t - T )}^{T} {y}_{i} ( t - T ) ) \\ = 2 {\sum }_{i = 1}^{N} {L}_{fi} {V}_{i} + 2 {\sum }_{i = 1}^{N - 1} {y}_{i}^{T} K ( {y}_{i} + 1 \\ ( t - T ) - {y}_{i} ) + \\ 2 {y}_{1}^{T} K ( {y}_{i} ( t - T ) yN ) + K {\sum }_{i = 1}^{N} ( {y}_{i}^{T} {y}_{i} - \\ {{y}_{i} ( t - T )}^{T} {y}_{i} ( t - T ) ) \\ = - 2 {\sum }_{i = 1}^{N} {S}_{i} - {\sum }_{i - 1}^{N - 1} {( {y}_{i} + 1 ( t - T ) - {y}_{i} + 1 )}^{T} \\ K ( {y}_{i} + 1 ( t - T ) - {y}_{i} ) - \\ {( {y}_{i} ( t - T ) - {y}_{N} )}^{T} K ( {y}_{i} ( t - T ) - {y}_{N} )\end{matrix} \qquad Equation 14$$

As V→0 output synchronization is achieved.

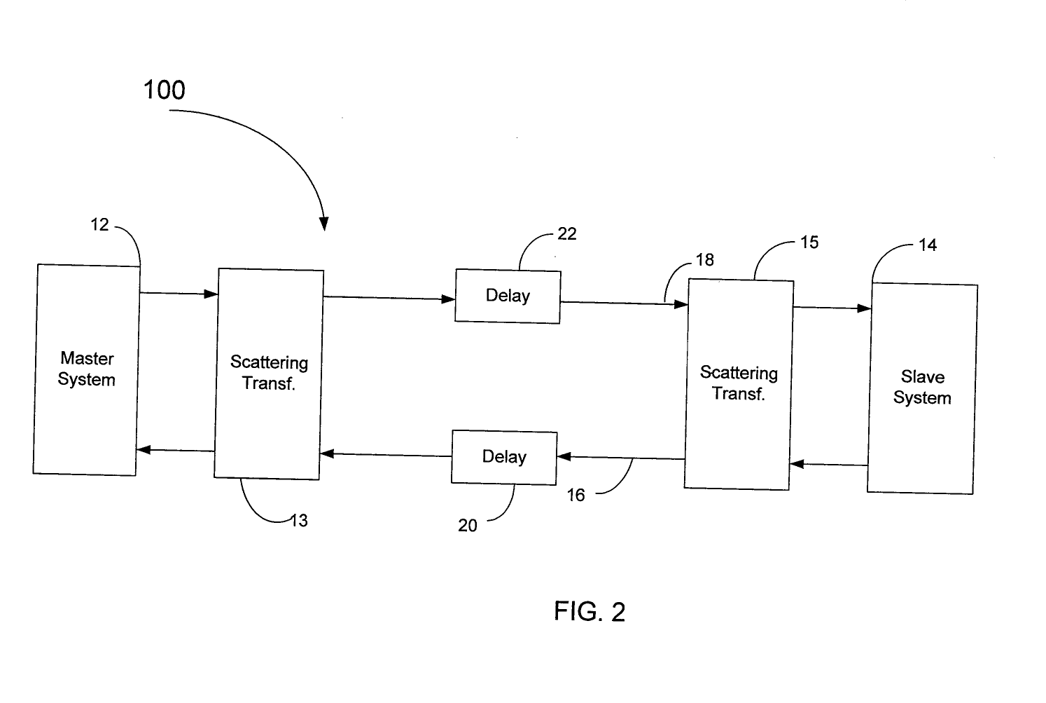

Now referring to FIG. 2, a schematic block diagram of a bilateral teleoperation 100 is shown. The master system 12 is coupled with the slave system 14 via a bi-directional communication path 16, 18. The bi-directional path 16, 18 introduces delays 20 and 22 and scattering transformations 13 and 15, respectively, in each of its two legs. That is, time delays 20, 22 are incurred in transmission of data between the master system and the slave system.

This architecture uses the passivity of formalism and concepts from network theory to construct such interconnection of passive blocks, which is dissipative. The master system 12 and slave system 14 are passive from force to velocity. This system, when interconnected with a passive human operator and remote environment is passive.

However, this configuration places an inherent limitation on the transparency (measure of position and force tracking) of the system. This architecture enables to drive the velocity errors between the master system 12 and the slave system 14 to zero, but can only guarantee the position tracking error to be bounded. That is, if the master system 12 and the slave system 14 start with an identical initial position and velocity, the slave system can faithfully track the master system 12 due to the convergence of the velocities. However, in the case where there is an initial offset between the master system 12 and the slave system 14, then this bilateral teleoperation 100 may not enable a convergence of the position tracking error to the origin.

Generally, teleoperation devices over the Internet, for example, utilize packets that are transmitted via an unreliable packet switched network. This unreliable packet switched network may induce packet drops, which may lead to an unreliable position drift between the master system 12 and the slave system 14. To address the aforementioned issues, a new architecture is proposed.

Assuming absence of friction or other disturbances, the Euler-Lagrange equations of motion for an n-link master and slave robot are given as:
Mₘ(qₘ)(\ddot{q}ₘ)+Cₘ(qₘ,\dot{q}ₘ)\dot{q}ₘ+gₘ(qₘ)=Fₕ+Tₘ
Mₛ(qₛ)\ddot{q}ₛ+Cₛ(qₛ,\dot{q}ₛ)qₛ+gₛ(qₛ)=Tₛ−Fₑ Equation 15
where qₘ, qₛ are n×1 vestors of joint displacements, qₘ, qₛ are the n×1 vectors of joint velocities, tₘ, tₘ are the n×1 vector of applied torques, M(q) is the n×n symmetric positive definite manipulator inertia matrix, C(q, q) is the n×n vector of Centripetal and Coriolis torques and g(q) is the n×1 vector of gravitational torques. In this analysis, the following assumptions are made:
The human operator and the environment can be modeled as passive systems with rₘ and rₛ as inputs respectively.
The operator and the environmental force are bounded by functions of the signals rₘ and rₛ respectively.
All signals belong to L₂ₑ, the extended L₂ space.

In order to achieve the design objectives, the motor torques are given:
Tₘ=−Fₘ−\hat{M}ₘ(qₘ) λ\dot{q}ₘ−Ĉₘ(qₘ,\dot{q}ₘ)λqₘ+ĝₘ(qₘ)
Tₛ=Fₛ=\hat{M}ₛ(qₛ)λ\dot{q}ₛ−Ĉₛ(qₛ,\dot{q}ₛ)λqₛ+ĝₛ₍qₛ) Equation 16
where \hat{M}i,Ĉi,ĝi i=m,s are estimates of the respective matrices available at that instant and the torques Fₘ and Fₛ are the additional torques as required for coordination control. As the dynamics are linearly parameterizable, the motor torques can also be written as follows:
Tₘ =−Fₘ−Yₘ(qₘ,\dot{q}ₘ)θₛ
Tₛ=Fₛ−Yₛ(qₛ,\dot{q}ₛ)\hat{θ}ₛ Equation 17
where Yₘ, Yₛ are known functions of the generalized coordinates and \hat{θ}ₘ,\hat{θ}ₛ are the time-varying estimates of the manipulators' actual constant p dimensional inertial parameters given by θₘ and θₛ respectively.

The master and slave dynamics of Equation 15 reduce to:
Mₘ\dot{r}ₘ+Cₘrₘ=Yₘ\tilde{θ}ₘ+Fₕ−Fₘ=T′ₘ
Mₛ\dot{r}ₛ+Cₛrₛ=Yₛ\tilde{θ}ₛ+Fₛ−Fₑ=T′ₛ Equation 18
where the vectors rₘ and rₛ are the new outputs of the bilateral teleoperator and are given as:
rₘ=\dot{q}ₘ+λqₘ
rₛ=\dot{q}ₛ+λqₛ Equation 19
and \tilde{θ}ₘ, \tilde{θ}ₛ are the estimation errors and are given as:
\tilde{θ}ₘ=θₘ−\hat{θ}ₘ
\tilde{θ}ₛ=θₛ−\hat{θ}ₛ Equation 20
which leads to

$${\int }_{0}^{t} {T}_{i}^{′ T} ( z ) {r}_{i} ( z ) ⅆ z \geq 0 \\ i = m , s \qquad Equation 21$$

Hence, the new master and slave dynamics are passive with (T′ₘ,rₘ) and (T′ₛ,rₛ) as the input output pairs.

Let the coupling torques for the two bilateral teleoperator be given as:
Fₛ=K(rₘ(t−T)−rₛ)
Fₘ=K(rₛ(t−T)−rₘ) Equation 22
where K is a positive definite diagonal matrix.

The time varying estimates of the uncertain parameters evolve as:
\dot{\hat{θ}}ₘ=ΓYₘ^{T}rₘ
\dot{\hat{θ}}ₛ=ΛYₛ^{T}rₛ Equation 23
where Γ and Λ are constant positive definite matrices. The coordination errors are defined between the master and slave robots as:
eₘ(t)=qₘ(t−T)−qₛ(t)
eₛ(t)=qₛ(t−T)−qₘ(t) Equation 24

Thus, two passive systems are coupled together with a control provided by Equation 11. To formalize this argument, the following theorem states the following:

“Consider the nonlinear bilateral teleoperator described by Equations 18, 22, and 23, then the master and slave robots synchronize and the coordination errors given by Equation 24 are globally exponentially stable.”

A proof for this theorem is as follows:

Define a positive definite function for the system as:

$$V = ( {r}_{m}^{T} {M}_{m} {r}_{m} + {r}_{s}^{T} {M}_{s} {r}_{s} + {\tilde{θ}}_{m}^{T} {Γ}^{- 1} {\tilde{θ}}_{m} + {\tilde{θ}}_{s}^{r} {Λ}^{- 1} {\tilde{θ}}_{s} ) + K {\int }_{t - T}^{t} ( {r}_{m}^{T} {r}_{m} + {r}_{s}^{T} {r}_{s} ) ⅆ s + 2 {\int }_{0}^{t} ( {F}_{e}^{T} {r}_{s } - {F}_{h}^{T} {r}_{m} ) ⅆ s \qquad Equation 25$$

The human operator and the remote environment are passive (by assumption). Hence:

$${\int }_{0}^{t} {F}_{e} {r}_{s} ⅆ s \geq 0 ; \\ - {\int }_{0}^{t} {F}_{h} {r}_{m} ⅆ s \geq 0 \qquad Equation 26$$

Thus the function V is positive-definite. The derivative of this function along trajectories of the system is given by:
\dot{V}=2rₘ^{T}(−Cₘrₘ+Fₕ+Fₘ+Yₘ\tilde{θ}ₘ)+r ₘ^{T}Mₘrₘ+r_{S}^{T}(−Cₛrₛ+Fₛ−Fₑ+Yₛ\tilde{θ}ₛ)+2r_{S}^{T}Mₛrₛ−2\tilde{θ}ₘ^{T}Yₘ^{T}rₘ−2\tilde{θ}ₘ^{T}Y_{S}^{T}rₛ+Krₘ^{T}rₘ−Krₛ(t−T)^{T}rₛ(t−T)+Kr_{S}^{T}rₛ−Krₘ(t−T)^{T}rₘ(t−T)+2Fₑ^{T}rₛ−2Fₕ^{T}rₘ Equation 27

Using the skew-symmetric property of robot dynamics, the derivative reduces to:
\dot{V}=2rₘ^{T}Fₘ+K(rₘ−rₛ(t−T))^{T}(rₘ+rₛ(t−T))+2r_{S}^{T}Fₛ+K(rₛ−rₘ(t−T))^{T}(rₛ+rₘ(t−T))
\dot{V}=2rₘ^{T}Fₘ−Fₘ^{T}(rₘ+rₘ+K⁻¹Fₘ)+2r_{S}^{T}Fₛ−F_{S}^{T}(rₛ+rₛ+K⁻¹Fₛ)
\dot{V}=−Fₘ^{T}K⁻¹Fₘ−F_{S}^{T}K⁻¹F_{s≦}0 Equation 28

As \dot{V}→0 output synchronization is achieved.

Additionally, although Fₘ and FₛεL₂. However, the following equation
Fₛ=\dot{e}ₘ+λeₘ Equation 29
can be viewed as an exponentially stable linear system with the state eₘ and an L₂ input given by Fs. Hence, the coordination error is globally exponentially stable. The result similarly holds for the coordination error eₛ.

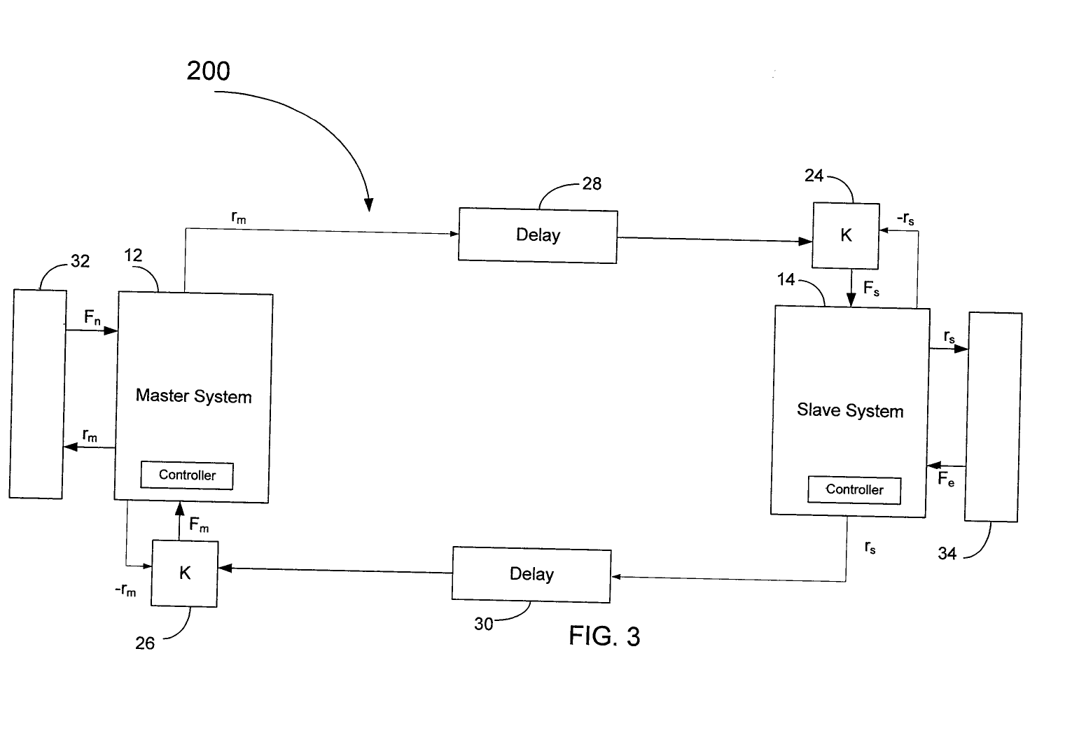

Now referring to FIG. 3, a schematic block diagram of a coordinated bilateral teleoperator 200 is shown. The master systems 12 and the slave system 14 produce output signals rₘ and rₛ, respectively. The output signals rₘ is communicated to a human operator 32, while the human operator communicates a force signal Fₕ to the master system 12. Similarly, the output signals rₛ is communicated to an environment system 34, while the environment system 34 communicates a force signal Fₑ to the slave system 14. Additionally, torque signals Fₘ and Fₛ are used for coordination control of the master and slave systems 12 and 14. The torque signal Fₛ is obtained by augmented by a gain K 24 a difference of the output signal rₘ delayed by a delay 28 and the output signal rₛ. The torque signal Fₘ is obtained in a parallel fashion with a delay 30 and a gain K 26.

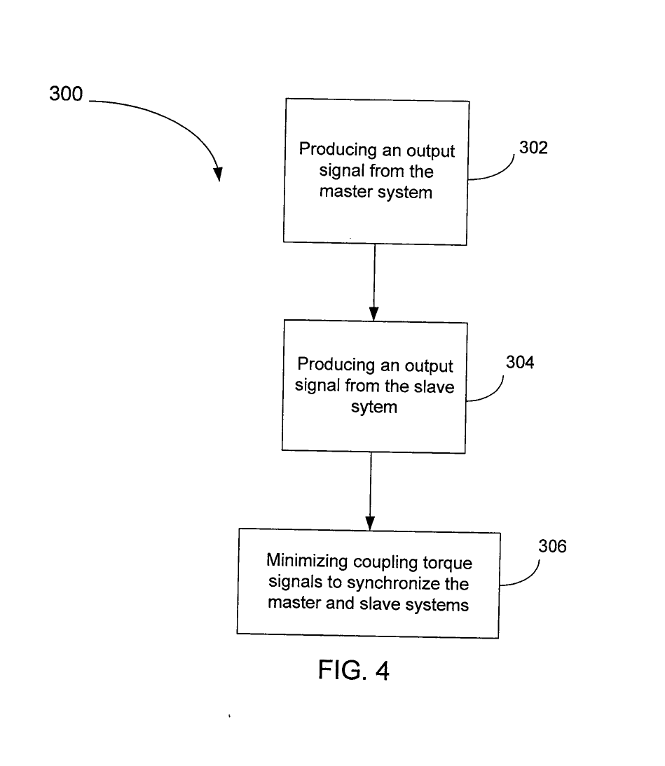

Now referring to FIG. 4, a flow diagram 300 of a method for conducting the coordinated bilateral teleoperation is shown. At step 302, the output signal rₘ is produced representing an action of a master system. At step 304, the output signal vector rₛ is produced representing a reaction by a slave system to the output signal rₘ. Then, at step 306, coupling torque signals Fₘ and Fₛ, which are functions of the output signals rₘ and rₛ and are provided to the master and the slave controllers respectively, are minimized during the bilateral teleoperation to synchronize the master and slave systems. This method provides delay independent exponential convergence of the tracking errors to the origin without using a scattering theory.

Now referring back to FIG. 1 which illustrates the above introduced example of 4 agents 1, 2, 3, and 4 connected via a balanced ring topology 10 representing their information topology. As such, the four agents 1, 2, 3, and 4 are coupled the following dynamics:
\dot{x}ᵢ=uᵢ and yᵢ=xᵢi=1,2,3,4.

Suppose that there is a constant delay T in the ring communication and let the control input be as follows:

$${u}_{i} ( t ) = {\sum }_{j ∈ {N}_{i}}^{} K ( {y}_{j} ( t - T ) - {y}_{i} ) , i = 1 , … , 4$$

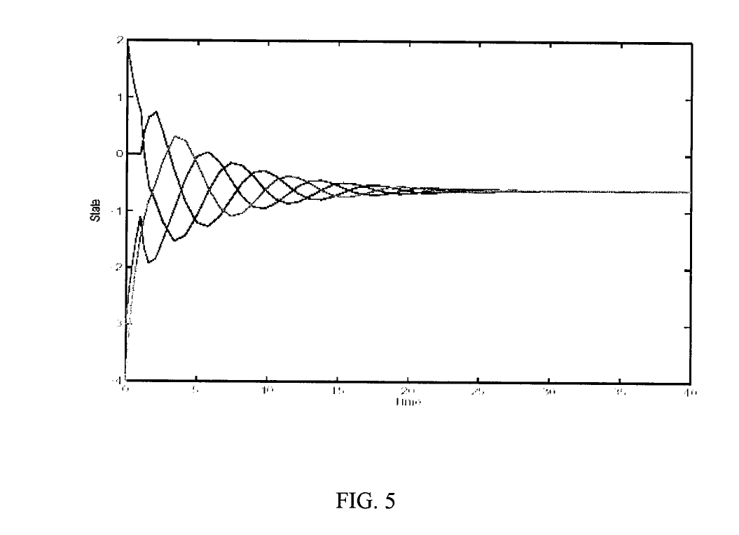

Thus, the representative closed loop system is as follows:
\dot{x}₁=K(x₂(t−T)−x₁); \dot{x}₂=K(x₃(t−T)−x₂)
\dot{x}₃=K(x₄(t−T)−x₃); \dot{x}₄=K(x₁(t−T)−x₄)
As such, in a simulation the outputs (states) of these 4 agents 1, 2, 3, and 4 synchronize as shown in FIG. 5.

There are numerous applications of the proposed technology, which embodies this method and system for synchronization of networked passive systems. It would be too lengthy of an endeavor to describe all of these numerous technological applications. As such, a small number of useful applications to bilateral teleoperations are described herein. Based on the teachings herein, one of ordinary skill in the art can incorporate the proposed method and systems for synchronization of networked passive systems in a variety of systems. Moreover, the scope of the invention includes equipments that incorporate the proposed controlling technology.

Bilateral teleoperations are useful in telerobotic and haptic applications. For example, there has been a rapid growth in minimally evasive surgery over the last few years. The benefits are less pain, shorter recovery time, fewer complications and reduced costs. This proposed technology can add a new dimension to remotely teleoperated surgical cases.

In the mining technology, teleoperation of underground mining equipment from a safe distance in areas where the mine roof is unsupported is common. Some mines have added video feedback to move the operators farther away from the equipment. The other applications are again of rescue robots. One such incident, widely reported in the media recently, demonstrated the need for such robots.

Space is categorized as a challenging environment. As such, space oriented organizations, such as NASA, have a lot of interest in this proposed technology. One of the primary goals of the NASA Telerobotic Program is to develop, integrate and demonstrate the science and technology of remote telerobotics leading to increases in operational capability, safety, cost effectiveness and probability of success of space missions. Other potential applications that NASA is seeking to develop include long-range science rovers, rock-internal Inspection and selection systems, aerobots, nanorovers and subsurface explorers. Another useful application for this proposed technology is remote space construction. The building of the International Space Station is beginning of the colonization of space, and teleoperation can be very helpful is assembling space structures remotely from earth. These applications are typically meant to be controlled from ground-based centers, which engender time-varying delays in the control signals which are moving back and forth across space. Therefore, the proposed technology can be substantially useful in these applications.

In Underwater Remotely Operated Vehicles (ROVs) applications, an operator may be controlling an undersea robot over the Internet. The robot itself may have an acoustic communication link to a surface vehicle which may have a wireless connection to the Internet. The entire connection is subject to varying time delays, limited bandwidth, packet collisions and other effects. The proposed technology forms a basis of such architecture for a ROV.

In the field of military defense, the potential applications of the proposed technology are in surveillance, search and rescue robots. Soldiers of the future can be robots, safely teleoperated from a remote location. A building up of intelligent mobile agents is also envisioned, which will penetrate into enemy territory and gather useful information. The use of such agents was employed in rescue operations in the 9/11 bomb blasts. The use of remote surgery is also useful for the department of defense, as conducting complex surgical procedures on the frontline in the battlefield may not be possible. The soldiers can avail the skill of experienced surgeons, who can operate from a hospital in Chicago on a patient anywhere in the world.

Teleoperators are also useful in conducting operations in hazardous environments, such as nuclear facilities. The risk to human life can be minimized if most of the operations in the nuclear plant can be conducted remotely. In the event of a nuclear catastrophe, like the one in Chernobyl, telerobots can be used to explore the facility and find means and ways to limit the damage.

The proposed technology has also a vast application scope in the entertainment industry. Projects involving landing a pair of teleoperated robotic vehicles on the Moon's surface have been considered as part of first private lunar missions. The targeted customers for such lunar mission include theme parks, television networks, internet users and scientists.

In education, teleoperations over the Internet can be used for conducting scientific experiments across universities. The proposed technology provides a great opportunity for students and researchers as the need for intercontinental travel is obviated. One such example is the Network for Earthquake Engineering Simulation grid (NEESgrid). This NEESgrid network links research sites across the United States of America, and offers remote access to the latest research tools.

Additional information and details are included in a technical paper, authored by the inventors and titled “On synchronization of Networked Passive Systems with Time Delays and Application to Bilateral Teleoperation”. This technical paper is attached in Appendix A, and is hereby incorporated by reference.

It is therefore intended that the foregoing detailed description be regarded as illustrative rather than limiting, and that it be understood that it is the following claims, including all equivalents, that are intended to define the spirit and scope of this invention.

1. A control system for output synchronization of a networked communication system, the system comprising:
a plurality of agents, each one of the plurality of agents being coupled to the networked communication system configured for data exchange between the plurality of agents; and
a plurality of controller blocks, each one associated with one of the plurality of agents,
wherein
each of the plurality of the controller blocks uses output signals received from the associated agent and from a subset of the plurality of agents to derive a synchronizing control for the associated agent, so that the output signals of the plurality of agents converge asymptotically with time and so that the plurality of agents are synchronized to each other with time.

2. A control system for output synchronization of a networked communication system according to claim 1, wherein the plurality of agents is governed by control affine passive dynamics.

3. A control system for output synchronization of a networked communication system according to claim 1, wherein the data exchange occurs with time delays.

4. A control system for output synchronization of a networked communication system according to claim 3, wherein the time delays are not equal to each other.

5. A control system for output synchronization of a networked communication system according to claim 1, wherein the output signals converge asymptotically when the plurality of agents is coupled to the networked communication system over bounded time intervals.

6. A control system for a bilateral teleoperation comprising:
a master system, including a master controller configured to produce an output signal rₘ representing an action of the master system, and configured for coupling to a networked communication system; and
a slave system, including a slave controller coupled to the master controller through the communication system via a bidirectional communication path, the slave controller configured to produce an output signal vector r, representing a reaction to the output signal rₘ, and
wherein
coupling torque signals Fₘ and Fₛ, which are functions of the output signals rₘ and rₛ and are provided to the master and the slave controllers respectively, are minimized during the bilateral teleoperation to synchronize the master system with the slave system.

7. A control system for a bilateral teleoperation according to claim 6, wherein the bidirectional communication path includes time delays.

8. A control system for a bilateral teleoperation according to claim 6, wherein the master system and the slave system are governed by control affine passive dynamics.

9. A control system for a bilateral teleoperation according to claim 7, wherein the time delays are not equal to each other.

10. A control system for a bilateral teleoperation according to claim 7, wherein the output signals rₘ and rₛ converge asymptotically when the master system and the slave system are coupled to the networked communication system over bounded time intervals.

11. A method for a bilateral teleoperation, the method comprising:
producing an output signal rₘ representing an action of a master system, the master system including a master controller configured for coupling to a networked communication system;
producing an output signal vector rₛ representing a reaction by a slave system to the output signal rₘ, the slave system including a slave controller coupled to the master controller through the networked communication system via a bidirectional communication path; and
minimizing coupling torque signals Fₘ and Fₛ, which are functions of the output signals rₘ and rₛ and are provided to the master and the slave controllers respectively, during the bilateral teleoperation to synchronize the master and slave systems.

12. A method for a bilateral teleoperation according to claim 11, wherein the bidirectional communication path includes time delays.

13. A method for a bilateral teleoperation according to claim 11, wherein the master system and the slave system are governed by control affine passive dynamics.

14. A method for a bilateral teleoperation according to claim 12, wherein the time delays are not equal to each other.

15. A method for a bilateral teleoperation according to claim 11, wherein the output signals rₘ and rₛ converge asymptotically when the master system and the slave system are coupled to the networked communication system over bounded time intervals.

16. An apparatus for a bilateral teleoperation, the apparatus comprising:
a unit for producing an output signal rₘ representing an action of a master system, the master system including a master controller configured for coupling to a communication system;
a unit for producing an output signal vector rₛ representing a reaction by a slave system to the output signal rₘ, the slave system including a slave controller coupled to the master controller through the communication system via a bidirectional communication path; and
a unit for minimizing coupling torque signals Fₘ and Fₛ, which are functions of the output signals rₘ and rₛ and are provided to the master and the slave controllers respectively, during the bilateral teleoperation to synchronize the master and slave systems.

17. An apparatus for a bilateral teleoperation according to claim 16, wherein the bidirectional communication path includes time delays.

18. An apparatus for a bilateral teleoperation according to claim 16, wherein the master system and the slave system are governed by control affine passive dynamics.

19. An apparatus for a bilateral teleoperation according to claim 17, wherein the time delays are not equal to each other.

20. An apparatus for a bilateral teleoperation according to claim 16, wherein the output signals rₘ and rₛ converge asymptotically when the master system and the slave system—are coupled to the networked communication system over bounded time intervals.

21. A robotic system for a bilateral teleoperation comprising:
a master robotic system, including a master robotic controller, configured to produce output signal rₘ representing an action of the master robot system, and configured for coupling to a communication system; and
a slave robotic system, including a slave robot and a slave controller coupled to the master robotic controller through the communication system via a bidirectional communication path, the slave controller configured to produce an output signal rₛ representing an action of the slave robot in reaction to the output signal rₘ;
wherein coupling torque signals Fₘ and Fₛ, which are functions of the output signals rₘ and rₛ and are provided to the master and the slave controllers respectively, are minimized during the bilateral teleoperation to synchronize the master and slave systems.

22. A robotic system for a bilateral teleoperation according to claim 21, wherein the bidirectional communication path includes time delays.

23. A robotic system for a bilateral teleoperation according to claim 16, wherein the master robotic system and the slave robotic system are—overned by control affine passive dynamics.

24. A robotic system for a bilateral teleoperation according to claim 22, wherein the time delays are not equal to each other.

25. A robotic system for a bilateral teleoperation according to claim 21, wherein the output signals rₘ and rₛ converge asymptotically when the master robotic system and the slave robotic system are coupled to the networked communication system over bounded time intervals.
